(19) United States
(12) Patent Application Publication
(10) Pub. No.: US 2022/0040039 A1
(43) Pub. Date: Feb. 10, 2022

(54) INTRAVENOUS FLUID BAG WARMER

(71) Applicant: Black Medical, Inc., Atlanta, GA (US)

(72) Inventors: Shakiratu A Ogunfuyi, Atlanta, GA (US); Ronald B. Woods, Atlanta, GA (US)

(73) Assignee: Black Medical, iNC., Atlanta, GA (US)

(21) Appl. No.: 17/394,309

(22) Filed: Aug. 4, 2021

Related U.S. Application Data
(60) Provisional application No. 63/061,017, filed on Aug. 4, 2020.

(51) Int. Cl. A61J 1/16; A61J 1/10

(52) U.S. Cl. CPC A61J 1/16; A61J 1/10; A61J 2200/72; A61J 2205/20; A61J 2200/42

(57) ABSTRACT

A warming sleeve for an intravenous fluid bag includes a heating element. The warming sleeve can include an elastic materially at least partially surrounding the heating element. The warming sleeve can include a layer of a material disposed between the heating element and an intravenous fluid bag. The layer of material can exchange heat between the heating element and a fluid within the intravenous fluid bag.

### CROSS-REFERENCE TO RELATED PATENT APPLICATIONS

The present application claims the benefit of and priority to U.S. Provisional Patent Application No. 63/061,017, filed on Aug. 4, 2020, the entire disclosure of which is incorporated by reference herein.

### BACKGROUND

In medical environments such as hospitals and ambulances, patients may be at risk of bodily heat loss. An acceptable human body temperature can range from 36.1° C. (97° F.) to 37.2° C. (99° F.) and maintenance of normothermic body temperature is crucial for the body to function at its optimum capability. Body temperature regulation is maintained by the hypothalamus at the base of the brain, which directs thermoregulation within the body as a mode of homeostasis. Thermoregulation inputs come from the skin, core tissues, spinal cord, and the brain. When external temperatures change, afferent sensing receives a stimulus from receptors on the skin and send signals via sensory nerves to the hypothalamus. Such responses can occur at as small as 0.1° C. change in temperature. In emergency medical settings in particular, hypothermia is a substantial issue with trauma patients in pre-hospital environments. Trauma patients may lose heat at an increased rate in comparison with non-trauma patients, resulting in redefined ranges for hypothermia. Therefore, there may be a need to facilitate maintaining body temperature in both trauma and non-trauma patients within medical settings. One possible solution is to warm intravenous fluids provided to a patient in such settings.

### SUMMARY OF THE INVENTION

At least one aspect is directed to a warming sleeve for an intravenous fluid bag. The warming sleeve can include a heating element. The heating element can be at least partially surrounded by an elastic material. The warming sleeve can include a layer of a material disposed between the heating element and an intravenous fluid bag. The layer of material can facilitate exchanging heat between the heating element and a fluid within the intravenous fluid bag.

At least one aspect is directed to a warming sleeve for an intravenous fluid bag. The warming sleeve can include a heating element having a wire. The wire can be at least partially surrounded by an elastic material. The warming sleeve can include a layer of nonwoven fabric disposed between the heating element and an intravenous fluid bag. The nonwoven fabric can facilitate exchanging heat between the heating element and a fluid within the intravenous fluid bag. The warming sleeve can include an insulation layer disposed between the heating element and an external environment.

It is to be understood that both the foregoing general description and the following detailed description are exemplary and explanatory and are intended to provide further explanation of the disclosure as claimed.

### BRIEF DESCRIPTION OF THE DRAWINGS

The accompanying drawings constitute a part of this specification, illustrate an embodiment of the disclosure, and together with the specification, explain the methods, systems disclosed herein. The accompanying drawings are not intended to be drawn to scale. For purposes of clarity, not every component may be labeled in every drawing. In the drawings:

FIG. 1 is a front view of a warming sleeve for an intravenous fluid bag, according to an exemplary implementation.

FIG. 2 is a side view of a portion of the warming sleeve of FIG. 1, according to an exemplary implementation.

FIG. 3 is a top view of a portion of the warming sleeve of FIG. 1, according to an exemplary implementation.

FIG. 4 is a schematic of a portion of the warming sleeve of FIG. 1, according to an exemplary implementation.

FIG. 5 is a front view of a portion of the warming sleeve of FIG. 1, according to an exemplary implementation.

FIG. 6 is a rear view of a portion of the warming sleeve of FIG. 1, according to an exemplary implementation.

FIG. 7 is a front view of a warming sleeve for an intravenous fluid bag, according to an exemplary implementation.

FIG. 8 is a front view of a warming sleeve for an intravenous fluid bag, according to an exemplary implementation.

FIG. 9 is a schematic of a warming blanket, according to an exemplary implementation.

FIG. 10 is a schematic of a warming attachment for an intravenous tube, according to an exemplary implementation.

FIG. 11 is a schematic of a warming lamp for a hospital bed, according to an exemplary implementation.

### DETAILED DESCRIPTION

Reference will now be made to the concepts illustrated in the drawings, and specific language will be used here to describe the same. It will nevertheless be understood that no limitation of the scope of the methods/systems is thereby intended. Alterations and further modifications of the features illustrated here, and additional applications of the principles of the methods/systems described herein as illustrated here, which would occur to a person skilled in the relevant art and having possession of this disclosure, are to be considered within the scope of the methods and systems described herein. The various concepts introduced above and discussed in greater detail below may be implemented in any of numerous ways, as the described concepts are not limited to any particular manner of implementation.

Referring now generally to the figures, the present disclosure relates generally to thermal management of entities within medical settings to, for example, reduce risk of hypothermia. For example, patients receiving intravenous fluid means may have a greater risk of becoming hypothermic if the temperature of the intravenous fluid falls below a certain threshold. Therefore, there may be a need for warming and/or regulating temperature of the intravenous fluid.

One solution relates to a warming sleeve. A warming sleeve can be provided to surround, enclose, or receive a portion of an intravenous fluid bag and facilitate heating and/or maintaining thermal management of intravenous fluid within the intravenous fluid bag, for example. The warming sleeve can include a heating element, such as a coil or wire with electric current, a 3D printed heating element, or an exothermic chemical reaction solution, to provide heat within the warming sleeve. Various layers of material of the warming sleeve can facilitate exchanging heat between the heating element and the intravenous fluid within the intravenous fluid bag.

In various implementations, the warming sleeve can include additional layers of insulation material to facilitate maintaining thermal regulation of the intravenous fluid. The warming sleeve can include various types of indicators to display an operating condition, such as temperature or state of power, of the warming sleeve. In various implementations, the warming sleeve may include a removable drip chamber attachment to facilitate maintaining temperature of the intravenous fluid leaving the intravenous fluid bag.

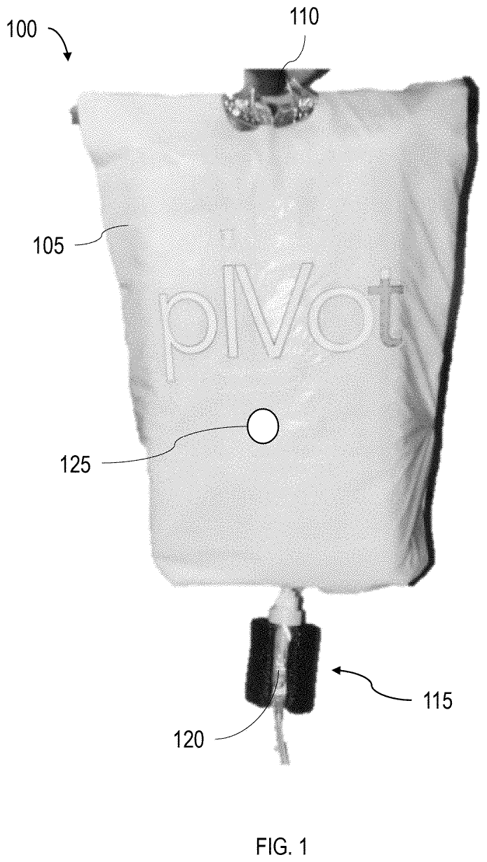

Referring now to FIG. 1, and in brief overview, a warming sleeve 100 is depicted surrounding a portion of an intravenous fluid bag 430, as discussed in greater detail below. The warming sleeve 100 may include a removably attached drip chamber attachment 115 that can couple to a conduit 120 fluidly attached to the intravenous fluid bag 430. The warming sleeve 100 may include one or more apertures, slots, openings, or the like to facilitate coupling the warming sleeve 100 and/or intravenous fluid bag 430 to an intravenous fluid bag 430 or intravenous bag support 110. The warming sleeve 100 may include one or more indicators 125 for displaying an operating condition of the warming sleeve 100.

Still referring to FIG. 1, and in greater detail, the warming sleeve 100 may include an external layer 105. For example, the external layer 105 can include various insulating materials including, but not limited to, fibers, thermoplastics, resins, foams, nomex honeycombs, or the like. The external layer 105 can include various waterproof materials including, but not limited to, plastics, fibers, polyurethanes, resins, elastomers, or the like. The external layer 105 can enclose one or more components of the warming sleeve 100 such that external layer 105 facilitates minimizing debris, fluid, dirt, or various other external environmental conditions from damaging or otherwise interfering with the warming sleeve 100.

In various implementations, the external layer 105 can fully enclose the intravenous fluid bag 430 such that the entire intravenous fluid bag 430 is not exposed to the external environment. In various implementations, the external layer 105 can include one or more slots, openings, apertures, or the like such that one or more portions of the intravenous fluid bag 430 are exposed to the external environment. For example, the external layer 105 can include an opening such that a conduit 120 can fluidly couple to the intravenous fluid bag 430. The external layer 105 can include an opening such that the intravenous fluid bag 430 can couple to the intravenous bag support 110 (e.g., pole, rod, hook, etc.), as another example.

As described in greater detail below, the warming sleeve 100 can include at least one removable attached drip chamber attachment 115. For example, the drip chamber attachment 115 can couple to various portions of the intravenous fluid bag 430. The drip chamber attachment 115 can couple to various components formed with, attached to, or otherwise coupled with the intravenous fluid bag 430. As shown in FIG. 1, the drip chamber attachment 115 can couple to a conduit 120 attached to the intravenous fluid bag 430. The drip chamber attachment 115 can facilitate regulating temperature of the intravenous fluid 435 within the intravenous fluid bag 430. For example, the drip chamber attachment 115 can include various insulating materials including, but not limited to, foam, polyethylene, fiber, plastic, or various other similar materials.

The warming sleeve 100 may include one or more indicators 125, according to an exemplary implementation. The indicator 125 may display an operating mode of the warming sleeve 100. For example, the indicator 125 may display whether the warming sleeve 100 is activated (e.g., on or off). The indicator 125 may display a temperature of the warming sleeve 100, as another example. The indicator 125 may display a time value associated with the warming sleeve 100, such as how long the warming sleeve 100 has been in use. The indicator 125 may display various other characteristics of the warming sleeve 100 including, but not limited to, an error, a level of charge, and a state of performance.

In various implementations, the indicator 125 may include one or more light sources for displaying the operating condition. For example, the indicator 125 may include a light-emitting diode (LED), a halogen incandescent light, a compact fluorescent lamp (CFL), an organic light-emitting diode (OLED), or the like. The indicator 125 may include a multi-colored light source (e.g., a multicolor LED) to display the operating condition. In various other examples, the indicator 125 may include an analog display for displaying the operating condition, such as an analog scale, clock, voltmeter, ammeter, or the like.

The indicator 125 may be integrally formed (e.g., sewn, integrated, printed, stamped, welded, etc.) with the warming sleeve 100. For example, the indicator 125 may be formed with a portion of the external layer 105. The indicator 125 may be formed with another component of the warming sleeve 100, as another example. In various other examples, the indicator 125 may be coupled to the warming sleeve 100 through various fasteners and/or adhesives. In still other implementations, the indicator 125 may be communicably coupled to the warming sleeve 100 through various wires or wireless means.

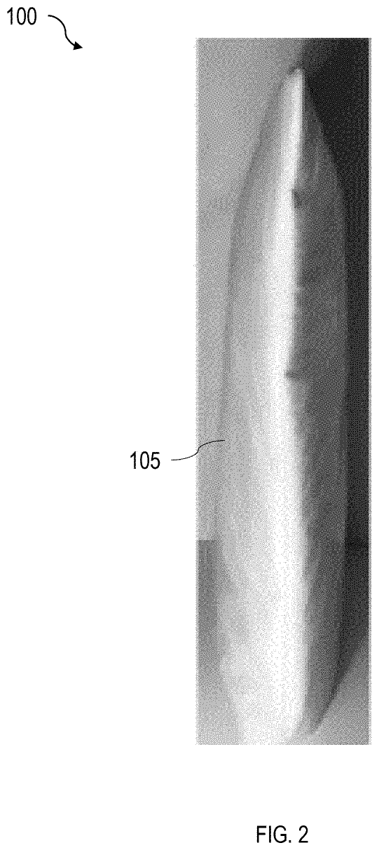

FIG. 2 depicts a side view of the warming sleeve 100, according to an exemplary implementation. As shown in FIG. 2, the warming sleeve 100 can enclose the intravenous fluid bag 430 such that the external layer 105 is disposed between a portion of the intravenous fluid bag 430 and the external environment. The warming sleeve 100 can vary in shape and/or size. For example, in some implementations, the warming sleeve 100 can have a thickness of about 25 millimeters. In other examples, the warming sleeve 100 can be thicker or thinner. While the exemplary implementation depicted in the figures includes a warming sleeve 100 shaped to conform to an intravenous fluid bag 430, the warming sleeve 100 can include various other shapes or configurations to provide heat to the intravenous fluid bag 430.

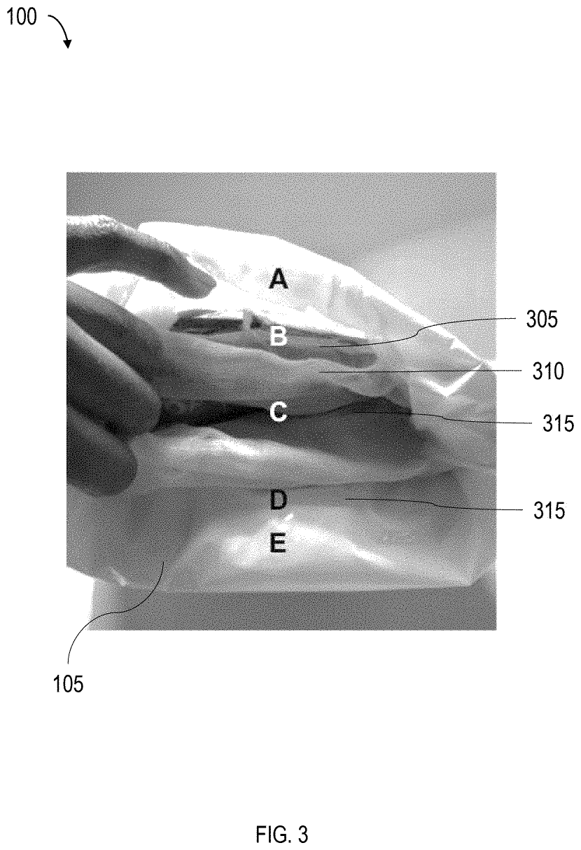

FIG. 3 depicts an open top view of the warming sleeve 100, according to an exemplary implementation. As shown in FIG. 3, the warming sleeve 100 can include several layers. The warming sleeve 100 can include one or more layers of material 310. For example, the material 310 may include a nonwoven material such as various cloths, sheets, webs, or other fibers and filaments including Kevlar, felt, nomex, Lamé, Terrycloth, or the like. In various other examples, the material 310 may include a woven material such as denim, broadcloth, poplin, corduroy, or the like. The material 310 can vary in size and/or shape. For example, in various implementations, the material 310 may have a thickness of about 1 millimeter (about 0.004 inches). In various other implementations, the material 310 may be thicker or thinner. In various examples, the material 310 may have a length of about 300 millimeters (about 12 inches). In various other examples, the material 310 may be longer or shorter. In some examples, the material 310 may have a width that is about equivalent to the width of a standard intravenous fluid bag. For example, the material 310 may have a width of about 250 millimeters (about 10 inches). In various other examples, the material 310 may be wider or smaller.

The warming sleeve 100 may include a plurality of layers of the material 310 that separately create various pockets 315 (e.g., slots, apertures, openings) for receiving and/or enclosing various components including the intravenous fluid bag 430 and/or a heating element 415, as discussed in greater detail below. In various implementations, the warming sleeve 100 may include a plurality of layers of the material 310 that are coupled together to create various pockets 315 for receiving and/or enclosing various components. In various other implementations, the warming sleeve 100 may include one layer of material 310. In still other various implementations, the warming sleeve 100 may include various other materials to receive the intravenous fluid bag 430 including, but not limited to, fabric, plastics, metals, or elastomers.

In various implementations, the material 310 may be formed with, attached to, or otherwise coupled with one or more portions of the external layer 105. For example, one or more layers of the material 310 may be integrally formed via various adhesive processes such as heat adhesives, hook and loop fastening, and bonding. One or more layers of the material 310 may be formed together through various needlework processes including, but not limited to, sewing and knitting, as another example. One or more layers of the material 310 may be formed through various fasteners such as buttons, screws, rivets, or the like.

One possible manufacturing process of the warming sleeve 100 is described below. A layer of material 310 (e.g., nonwoven material) may be measured to accommodate a standard 100 milliliter intravenous fluid bag 430. According to one example, four layers of material 310 shaped generally as a rectangle are used. In various other examples, more or less layers of material 310 may be used. In some examples, different shapes of material 310 may be used including, but not limited to, triangular, circular, or hexagonal. A hemi-oval piece of each of the layers of material 310 can be cut, extruded, or otherwise formed at a top portion of each layer of material 310. Each layer of material 310 may then be placed on top of one another and sewn together along a portion of each edge, omitting the semi-oval portions and bottommost edge. This process may be repeated for several additional layers of material 310 to create the pockets 315 for receiving various components of the warming sleeve 100. The components of the warming sleeve 100 may be formed with a layer of material 310 or with another component through various adhesives, fasteners, or the like. The layers of material 310 may additionally be surrounded by a lightweight material to create the external layer 105. According to various other implementations, the warming sleeve 100 may be manufactured according using other means and methods.

The warming sleeve 100 can include an insulation layer 305. For example, the insulation layer 305 can include various insulating materials including fiberglass, silicone, or other similar materials. The insulation layer 305 can be disposed between one or more portions of the warming sleeve 100. For example, the insulation layer 305 may be disposed between one or more layers of the material 310. The insulation layer 305 may be disposed between a layer of the material 310 and another component of the warming sleeve 100 including the external layer 105 and/or the heating element 415. The insulation layer 305 may vary in size and/or shape. For example, the insulation layer 305 may vary in thickness. In some examples, the insulation layer 305 may have a thickness of about 50 millimeters (about 2 inches). In various other examples, the insulation layer 305 may be thicker or thinner.

In various implementations, the insulation layer 305 may have a thickness that is greater than the thickness of the material 310. For example, the insulation layer 305 may have a thickness that is 1% greater than the thickness of the material 310. The insulation layer 305 may have a thickness that is 50% greater than the thickness of the material 310, as another example. The insulation layer 305 may have a thickness that is 200% greater than the thickness of the material 310. In various other examples, the insulation layer 305 and the material 310 may have the same thickness.

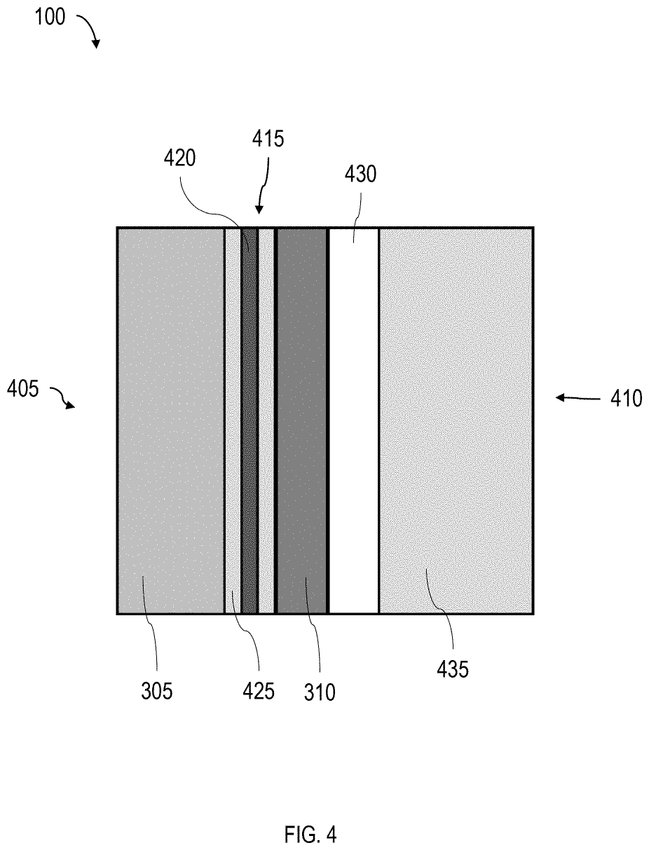

FIG. 4 depicts a schematic of a cross-sectional view of the warming sleeve 100, according to an exemplary implementation. For example, the schematic of FIG. 4 depicts one example of the order of layers of one portion of the warming sleeve 100 from a first end 405 to a second end 410. For example, the first end 405 may be a portion of the warming sleeve 100 close to the external layer 105 and the second end 410 may be a portion of the intravenous fluid 435 within the intravenous fluid bag 430. In various implementations, the insulation layer 305 may be disposed between the heating element 415 and the external layer 105. The insulation layer 305 may be disposed between the heating element 415 and a layer of the material 310, according to another example. The insulation layer 305 may be disposed between two layers of the material 310, according to yet another example.

The heating element 415 may include various configurations to provide heat for the warming sleeve 100. For example, the heating element 415 may include a source 420 and an elastic material 425 partially surrounding the source 420. The source 420 may include an electrical heating source, such as a wire (coil, cable) configured to transmit electric current to create heat. For example, the heating element 415 may include a nichrome wire, such as 26 gauge nichrome wire. In various other implementations, the heating element 415 may include thicker or thinner wire. The heating element 415 may include various different types of wires or coils. For example, the heating element 415 may include wires made of one or more metallic materials. The heating element 415 may vary in size. For example, the heating element 415 can be configured to include about 4.75 meters of wiring. In various other examples, the heating element 415 may include more or less wiring. The heating element 415 may include various wires of varying resistances. For example, the heating element 415 may include a wire with a resistance of about 42 ohms. In various other examples, the heating element 415 may include wires with a higher or lower level of resistance.

In various other examples, the heating element 415 may include a chemical heating source. For example, the heating element 415 may be based on an exothermic reaction between two or more substances. The heating element 415 may include two compartments or components that each contain a substance. For example, one compartment may contain a heat-producing composition, while a second compartment may contain an activating solution. Possible chemical reactions can include, but is not limited to, iron oxide, calcium chloride and magnesium, and sodium hydroxide. The two compartments may be separated by a frangible seal, partition, or the like, such that when the seal breaks, the substances are able to mix to initiate an exothermic reaction and produce heat. For example, the compartments may include plastic or glass encasing the substances. According to one example, the source 420 may include a first compartment containing the heat-producing composition and a second compartment containing the activation solution. The source 420 may also include a partition that is configured to break upon pressure or force to initiate such reaction.

The warming sleeve 100 utilizing a chemical heating element can be used in a variety of different ways. For example, the warming sleeve 100 may be configured for a singular use. In this implementation, the heating element 415 may be formed with the warming sleeve 100 (e.g., integrally fixed with) such that the warming sleeve 100 is used for one activation of the heating element 415 (e.g., one activation of an exothermic reaction) such that heat is exchanged between the heating element 415 and the fluid within the intravenous fluid bag 430 for a predetermined amount of time (e.g., until heat from the exothermic reaction subsides). After such activation, the warming sleeve 100 may be disposed. In various other implementations, the warming sleeve 100 may be configured to be reusable. For example, the heating element 415 can be replaced, repaired, or otherwise removed within the warming sleeve 100 such that one warming sleeve 100 can be used for several activation cycles of the heating element 415.

In still various other examples, the source 420 of the heating element 415 may include a Positive Temperature Coefficient (“PTC”) heating source. For example, the PTC heating source may be made from various additive manufacturing process, such as 3D printing, jetting, fusion, or the like. In various other examples, the PTC heating source may be manufactured from various other manufacturing techniques including, but not limited to, molding, forging, milling, turning, and laser cutting. The PTC heating source may include a portion of polyester, or similar material, configured to enable the PTC heating source to bend such that the heating element 415 can surround (e.g., wrap around) the intravenous fluid bag 430. The heating element 415 can be coupled to one or more portions of the warming sleeve 100 such that the heating element 415 is stationary within the warming sleeve 100. For example, the heating element 415 may be coupled to a layer of material 310. The heating element 415 may be coupled to an insulation layer 305, as another example. The heating element 415 may be coupled directly to the intravenous fluid bag 430, as yet another example.

The heating element 415 may include one or more elastic materials 425. For example, the elastic material 425 can at least partially surround the one or more wires, chemical heating compartments, or PTC heating sources. In various implementations, the elastic material 425 can surround the source 420 such that the source 420 is not exposed. In various other implementations, the elastic material 425 may partially surround the source 420. The elastic material 425 may be rubber, silicone, or another similar insulator to provide a protective coating around the source 420. As shown in FIG. 4, the elastic material 425 can circumferentially surround the source 420 such that the source 420 is not exposed to another material within the warming sleeve 100. In various other implementations, the source 420 may at least partially be exposed to another component of the warming sleeve 100.

The heating element 415 can receive power (e.g., electrical current) from various sources. For example, the heating element 415 may be configured to receive power from an outlet, such as a wall outlet. Accordingly, the warming sleeve 100 may be configured to plug into an outlet. The heating element 415 may be configured to receive power from an electrically charged battery, as another example. Accordingly, the warming sleeve 100 may be configured to operate without being plugged into an outlet. In various implementations, the warming sleeve 100 may include one or more components to receive a battery to couple to the heating element 415. In various other implementations, the warming sleeve 100 may not receive any electrical current at all. For example, the warming sleeve 100 may be operated solely from the exothermic reaction of the heating element 415, as discussed above.

The heating element 415 may abut, or otherwise be positioned near, one or more layers of the material 310, as shown in FIG. 4. For example, the elastic material 425 of the heating element 415 may be positioned near the material 310 such that the material 310 can absorb, transmit, or otherwise exchange heat provided by the heating element 415. For example, the warming sleeve 100 may include on layer of material 310 disposed between the heating element 415 and the intravenous fluid bag 430. In various other examples, the warming sleeve 100 may include more than one layer of material 310 disposed between the heating element 415 and the intravenous fluid bag 430. In still various other examples, the heating element 415 may be positioned directly next to the intravenous fluid bag 430.

The material 310 may be configured to facilitate exchanging heat between the heating element 415 and an intravenous fluid 435 within the intravenous fluid bag 430. For example, the material 310 may be disposed proximate the intravenous fluid bag 430 such that heat from the heating element 415 can be exchanged, via conduction and convection, to the intravenous fluid 435.

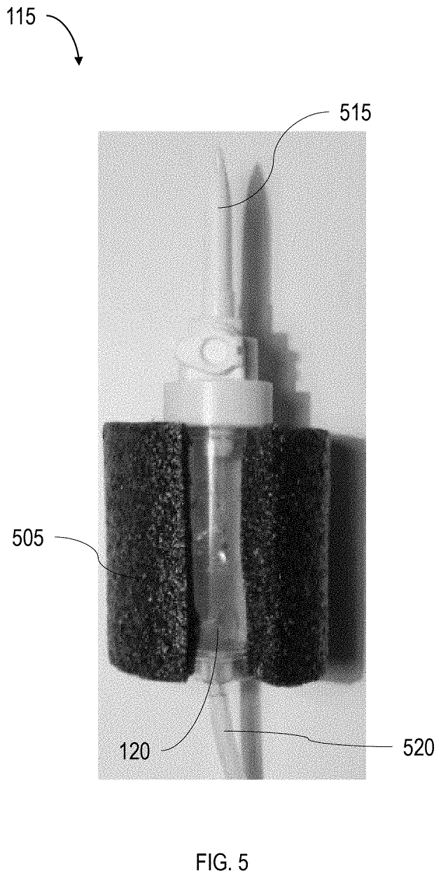

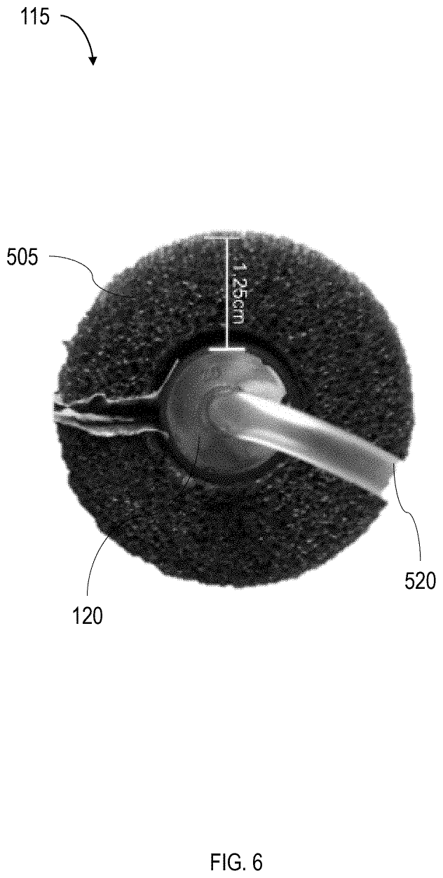

FIGS. 5 and 6 depict more detailed views of the drip chamber attachment 115, according to an exemplary implementation. As shown in FIGS. 5 and 6, the drip chamber attachment 115 can include one or more components that couple to a fluid conduit 120. In various implementations, the drip chamber attachment 115 can completely circumferentially surround the fluid conduit 120 (e.g., such that the fluid conduit 120 is not exposed). In various implementations, the drip chamber attachment 115 can partially surround the fluid conduit 120, as shown in FIG. 5. The drip chamber attachment 115 can include one or more insulating materials 505 to facilitate thermal management of the intravenous fluid 435 within the fluid conduit 120. For example, the drip chamber attachment 115 can couple to a portion of the fluid conduit 120 proximate the intravenous fluid bag 430, such as directly below a connection point 515 of the intravenous fluid bag 430 and the fluid conduit 120. The drip chamber attachment 115 can facilitate maintaining heat within the intravenous collected within the fluid conduit 120 (e.g., within a drip chamber of an intravenous fluid bag 430). In various other implementations, the drip chamber attachment 115 may couple to various other portions of the intravenous fluid bag 430 including, but not limited to, the tubing 520 configured to provide the fluid to a patient.

The drip chamber attachment 115 can vary in size and/or shape. For example, the drip chamber attachment 115 can extend partially along the length of the fluid conduit 120 (e.g., drip chamber), as shown in the figures. According to one example, the drip chamber attachment 115 may have a length of about 50 millimeters. In various other examples, the drip chamber attachment 115 may couple to a larger portion of the fluid conduit 120. The drip chamber attachment 115 may couple to a smaller portion of the fluid conduit 120, as yet another example. The drip chamber attachment 115 may vary in thickness (e.g., extension of material 505 radially from fluid conduit 120). For example, the drip chamber attachment 115 may include a thickness of about 125 millimeters. In various other examples, the drip chamber attachment 115 may be thicker or thinner. While the exemplary implementation of the drip chamber attachment 115 may include a cylindrical shape to circumferentially surround the fluid conduit 120, the drip chamber attachment 115 may include various other shapes according to other implementations. For example, the drip chamber attachment 115 may be rectangular, hexagonal, or various other shapes to enclose the fluid conduit 120.

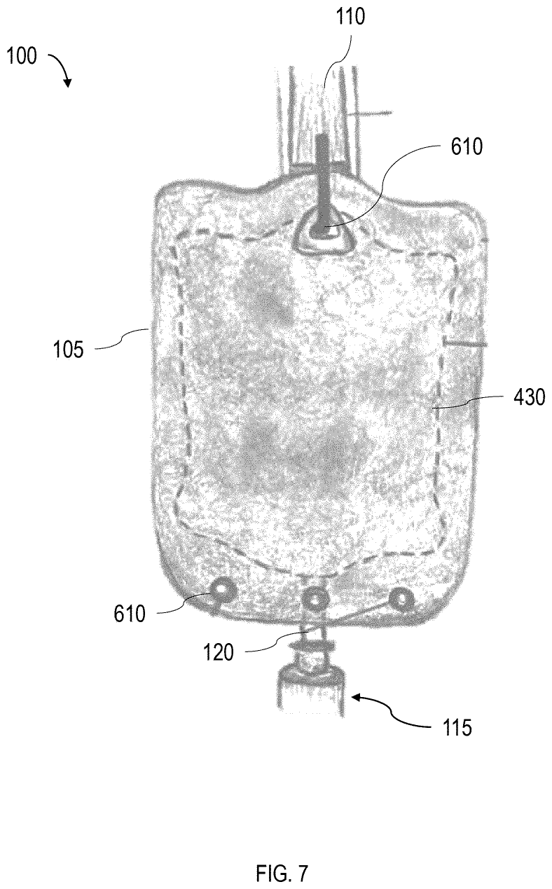

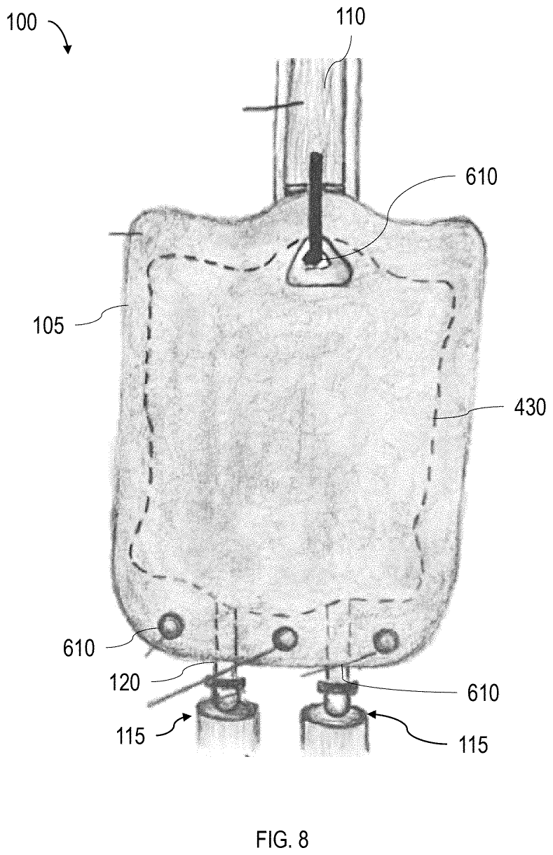

FIGS. 7 and 8 depicts various implementations of the warming sleeve 100. For example, as shown in FIG. 7, the intravenous fluid bag 430 can couple to a single fluid conduit 120 for transmitting fluid to a patient. In various other implementations, such as that shown in FIG. 8, the intravenous fluid bag 430 can couple to more than one fluid conduit 120. Accordingly, the warming sleeve 100 may include more than one drip chamber attachment 115. The warming sleeve 100 may include multiple apertures 610 allowing for the fluid conduit 120 to fluidly couple to the intravenous fluid bag 430, for example. The apertures 610 may facilitate coupling the intravenous fluid bag 430 to the intravenous bag support 110, as another example. The apertures 610 may facilitate coupling one portion of the warming sleeve 100 to another portion of the warming sleeve 100 (e.g., via fasteners, pins, rivets, etc.), as yet another example.

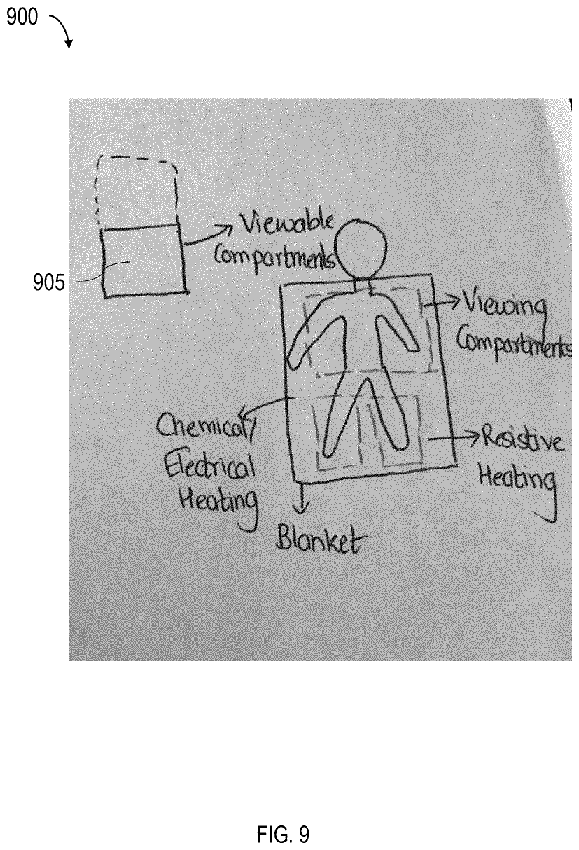

FIG. 9 depicts a warming blanket 900 with compartments, according to an exemplary implementation. As shown in FIG. 9, a warming blanket 900 similar to the warming sleeve 100 may be provided to facilitate warming a patient and/or maintaining body temperature. For example, the warming blanket 900 may include one or more viewing compartments 905 positioned at various locations throughout the warming blanket 900. The viewing compartments 905 may include a translucent cover, a detachable area of fabric, an aperture, or similar feature in which is configured to facilitate viewing within the blanket 900 (e.g., seeing through the blanket material). According to one implementation, the warming blanket 900 may include a small section (e.g., 1%, 5%, 10%, etc. of the blanket 900) that is made of a translucent material (e.g., plastic) that is integrally formed with the blanket 900 such that a viewing compartment 905 is formed for that section. In another implementation, the warming blanket 900 may include one or more apertures within the blanket 900 that are configured to be disconnected from the blanket 900 at one or more locations (e.g., pulled back, zipped up, fastened, etc.).

In various implementations, the warming blanket 900 may include one or more heating elements 415. For example, the heating element 415 may be formed with one or more viewing compartments 905 of the warming blanket 900. The heating element 415 may be formed with (e.g., sewn into) the material of the blanket 900, as another example. The heating element 415 may be coupled with one or more portion of the blanket 900 through pockets, buttons, or the like, as yet another example. The heating element 415 may include a chemical heating element (e.g., heat-producing solution mixing with an activation composition) or a resistive heating element (e.g., wires, coils, electric heating).

The warming blanket 900 may include various materials. For example, the warming blanket 900 may be formed of various fabrics including, but not limited to, wool, cotton, chiffon, linen, velvet, or the like. The warming blanket 900 may include various materials to facilitate regulating temperature. For example, the warming blanket 900 may include one or more insulating materials including, but not limited to, fiber, foam, thermoplastics, and fabrics, formed with or attached to, the blanket 900. The warming blanket 900 may vary in size and/or shape. In various implementations, the warming blanket 900 may be rectangular in shape. In various other implementations, the warming blanket 900 may include other shapes including circular, triangular, or another similar shape.

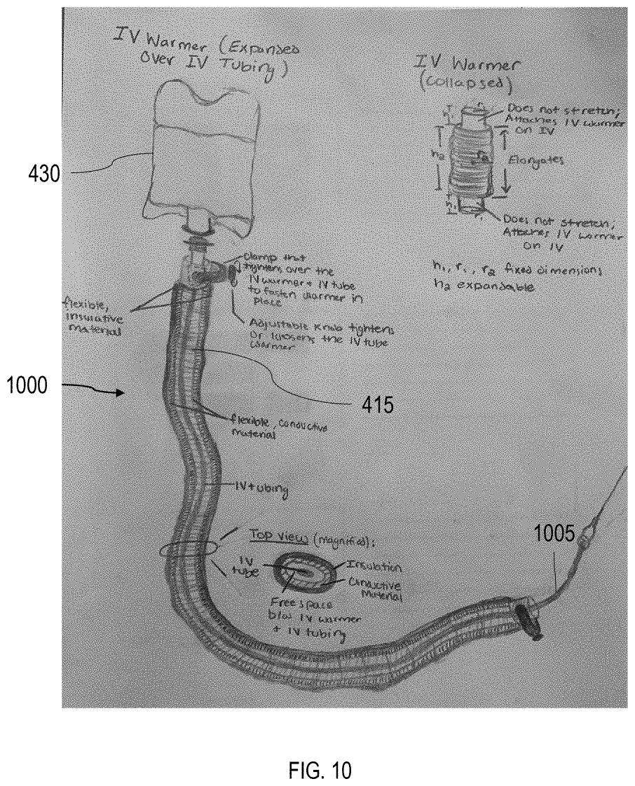

FIG. 10 depicts a detachable warming sleeve 1000 for an intravenous fluid tube, according to an exemplary implementation. For example, the detachable warming sleeve 1000 can couple to an intravenous tube 1005 fluidly coupled with the intravenous fluid bag 430. The detachable warming sleeve 1000 can include a heating element 415 to facilitate warming the intravenous tube 1005. For example, the heating element 415 may include a chemical heating element (e.g., heat-producing solution mixing with an activation composition) or a resistive heating element (e.g., wires, coils, electric heating).

In various implementations, the detachable warming sleeve 1000 may be cylindrical in shape such that the detachable warming sleeve 1000 can circumferentially surround a portion of the intravenous tube 1005. In various other examples, the detachable warming sleeve 1000 may include various other shapes to couple to the intravenous tube 1005. In various implementations, the detachable warming sleeve 1000 may extend the full length of the intravenous tube 1005. In other implementations, the detachable warming sleeve 1000 may only extend for a portion of the intravenous tube 1005.

The detachable warming sleeve 1000 may include various materials to facilitate coupling to the intravenous tube 1005. For example, the detachable warming sleeve 1000 may include woven or nonwoven materials, fabrics, or the like for protecting the heating element 415. The detachable warming sleeve 1000 may include various elastic materials to facilitate protecting the heating element 415. The detachable warming sleeve 1000 may include one or more insulating materials including foam or fiber. The detachable warming sleeve 1000 may include one or more fasteners, adhesives, or similar connecting components to facilitate coupling the detachable warming sleeve 1000 to the intravenous tube 1005. The detachable warming sleeve 1000 may include various materials to facilitate regulating temperature of the fluid within the intravenous tube 1005 (e.g., intravenous fluid provided to a patient).

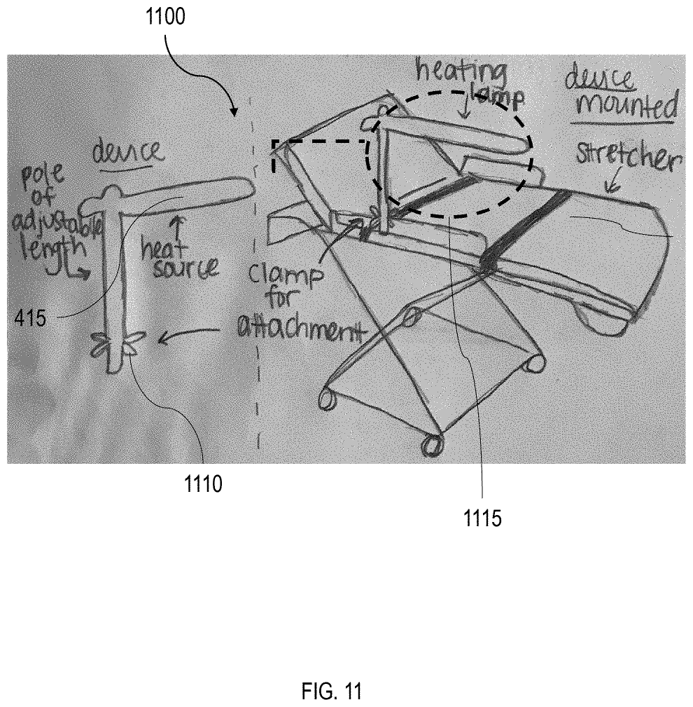

FIG. 11 depicts a heating lamp 1100 for bed 1105, according to an exemplary implementation. For example, the heating lamp 1100 may couple to a portion of a hospital bed, emergency medical stretcher, or the like. In various implementations, the heating lamp 1100 may couple to a side portion 1115 of the bed 1105. For example, the heating lamp 1100 may include a connecting component 1110 that includes one or more clamps, fasteners, or the like, for coupling to a side portion 1115 of the bed 1105. The heating lamp 1100 may include one or more heating elements 415. For example, the heating element 415 may include a chemical heating element (e.g., heat-producing solution mixing with an activation composition) or a resistive heating element (e.g., wires, coils, electric heating). The heating element 415 may include an infrared light, an ultraviolet light, or a similar light configured to produce heat, as another example.

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only as well as both ‘A’ and ‘B’. Such references used in conjunction with “comprising” or other open terminology can include additional items.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

The construction and arrangement of the warming sleeve as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, other elements of the various embodiments may be incorporated or utilized with any of the other embodiments disclosed herein.

The foregoing method descriptions and the process flow diagrams are provided merely as illustrative examples and are not intended to require or imply that the steps of the various embodiments must be performed in the order presented. The steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, and the like. When a process corresponds to a function, the process termination may correspond to a return of the function to a calling function or a main function.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A warming sleeve for an intravenous fluid bag, comprising:
a heating element at least partially surrounded by an elastic material; and
a layer of a material disposed between the heating element and an intravenous fluid bag and exchanging heat between the heating element and a fluid within the intravenous fluid bag.

2. The warming sleeve of claim 1, further comprising an insulation layer disposed between the heating element and an external environment.

3. The warming sleeve of claim 2, wherein the insulation layer includes at least one of a fiberglass material and a silicone material.

4. The warming sleeve of claim 2, wherein the thickness of the insulation layer is greater than the thickness of the layer of the material disposed between the heating element and the intravenous fluid bag.

5. The warming sleeve of claim 2, further comprising a second layer of the material disposed between the heating element and the insulation layer.

6. The warming sleeve of claim 1, wherein the layer of the material disposed between the heating element and the intravenous fluid bag is a nonwoven material.

7. The warming sleeve of claim 6, wherein the nonwoven material is a nonwoven fabric.

8. The warming sleeve of claim 1, wherein the heating element includes at least one of a wire, a chemical solution, and a 3D printed element.

9. The warming sleeve of claim 1, the heating element to receive power from at least one of a power outlet source and a battery source.

10. The warming sleeve of claim 1, further comprising an indicator to display an operating condition of the warming sleeve.

11. The warming sleeve of claim 10, wherein the operating condition is based on a metric of a predetermined threshold corresponding to at least one of a temperature, a time, a power output, and an error associated with the heating element.

12. The warming sleeve of claim 10, wherein the indicator includes a multicolor light source.

13. The warming sleeve of claim 1, wherein the elastic material surrounding the heating element is at least one of a rubber material and a silicone material.

14. The warming sleeve of claim 1, further comprising a drip chamber insulation attachment configured to receive a portion of a conduit fluidly coupled with the intravenous fluid bag.

15. The warming sleeve of claim 14, wherein the drip chamber insulation attachment includes a foam material.

16. A warming sleeve for an intravenous fluid bag, comprising:
a heating element including a wire at least partially surrounded by an elastic material;
a layer of a nonwoven fabric disposed between the heating element and an intravenous fluid bag and exchanging heat between the heating element and a fluid within the intravenous fluid bag; and
an insulation layer disposed between the heating element and an external environment.

17. The warming sleeve of claim 16, further comprising a drip chamber insulation attachment configured to receive a portion of a conduit fluidly coupled with the intravenous fluid bag.

18. The warming sleeve of claim 16, further comprising an indicator including a light source.

19. The warming sleeve of claim 16, wherein the elastic material surrounding the wire is at least one of a rubber material and a silicone material.

20. The warming sleeve of claim 16, wherein the insulation layer includes at least one of a fiberglass material and a silicone material.
